(19) United States
(12) Patent Application Publication
(10) Pub. No.: US 2014/0026632 A1
(43) Pub. Date: Jan. 30, 2014

(54) CONNECTION ELEMENT AND SETTING DEVICE FOR A CONNECTION ELEMENT

(71) Applicant: GESIPA BLINDNETTECHNIK GMBH, Moerfelden-Walldorf (DE)

(72) Inventors: Thomas BAMBERGER, Kelkheim (DE); Christoph DUMPE, Gladbeck (DE); Richard GAERTNER, Griesheim (DE); Lothar WILLE, Moerfelden-Walldorf (DE); Hans-Ulrich HARDER, Moerfelden-Walldorf (DE)

(73) Assignee: GESIPA BLINDNIETTECHNIK GMBH, Moerfelden-Walldorf (DE)

(21) Appl. No.: 13/952,033

(22) Filed: Jul. 26, 2013

(30) Foreign Application Priority Data
Jul. 27, 2012 (EP) 12005479.6

(51) Int. Cl. B21J 15/04; F16B 19/10; B21J 15/10

(52) U.S. Cl. CPC B21J 15/043; B21J 15/105; F16B 19/10
USPC 72/391.4; 411/500

(57) ABSTRACT

Connection element and connection element setting device and system. Connection element includes a set head and a stem, including a wall surrounding a longitudinal channel, connecting to the set head. The wall has at least one longitudinal slot located between the set head and an end section facing away from the set head, and the end section is smooth on an inside facing the longitudinal channel.

### CROSS-REFERENCE TO RELATED APPLICATIONS

The present application claims priority under 35 U.S.C. §119 of European Patent Application No. 120 05 479.6, filed Jul. 27, 2012, the disclosure of which is expressly incorporated by reference herein in its entirety.

### BACKGROUND OF THE INVENTION

1. Field of the Invention

Embodiments of the invention relate to a connection element with a set head and a stem connecting to the set head. The stem has a wall surrounding a longitudinal channel, and the wall has at least one longitudinal slot between the set head and an end section facing away from the set head.

Furthermore, embodiments of the invention relate to a setting device for a connection element. The connection element has a set head and a stem that connects to the set head and has a wall surrounding a longitudinal channel. The wall has at least one longitudinal slot between the set head and an end section facing away from the set head. The setting device has a counter-holder, a pull drive, and a pulling head moveable relative to the counter-holder in a direction of pull by means of the pull drive.

2. Discussion of Background Information

For the connection of larger structural elements, as they are used, e.g., in modules for buildings or trucks, two or more structural elements are arranged on top of one another such that bores in the structural elements are aligned. A connection element can then be guided through the aligned bores. A screw that is inserted through the bores, for example, can be used as a connection element. However, it is necessary here to have access from the other side of the structural elements in order to place a washer and a nut onto the screw and tighten it there. In many cases, this is only possible if two people are available for the assembly. Furthermore, the use of screws is laborious for the technician. Normally, screws are tightened using hammer-drive screws, which produce unpleasant vibrations and also cause considerable noise.

Therefore, a connection element of the type generally described above has been used, which includes an internal thread arranged in the end section. In order to attach the connection element, the connection element is guided through the aligned bores of the structural elements and screwed onto a pulling mandrel. However, this screwing on can occur before the connection element is guided through the aligned bores or afterwards. When the connection element has been guided through the bores, the pulling mandrel is acted on by a tensile force and is, as it were, pulled out of the connection element. In this manner, the stem bulges out between the longitudinal slots and forms a type of closing head, which bears against the “back side” of the last structural element. Once the deformation is complete, the pulling mandrel is screwed out of the connection element again. The screwing in and out of the pulling mandrel requires additional time and is relatively complicated, such that no advantages worth mentioning result in comparison with the use of a screw, if it is disregarded that a connection element of this type can be set from a single side.

### SUMMARY OF THE EMBODIMENTS

Embodiments of the invention are directed to providing a connection of structural elements in a simple manner.

Accordingly, a connection element of the type named generally set forth at the outset additionally includes an end section that is smooth on its inside facing the longitudinal channel.

A connection element of this type can be assembled and deformed relatively easily and without many working steps being necessary for this purpose. Because the end section is smooth on its inside, a tool can be guided without obstructions into the end section or even through the end section. The tool then only needs to be expanded, that is, a non-positive, positive or frictional fit must be produced between the tool and the end section, such that a deformation of the stem results when the tool is pulled in a direction out of the connection element. This will be explained in greater detail further below. It is to be understood that the term “smooth” is not to be construed all too narrowly. The end section can indeed have a certain roughness. However, the end section does not have on its inside an attachment contour that needs to be connected to a pulling mandrel or the like. Instead, it is sufficient if the tool that is used for deforming the stem bears against the end section in the non-positive, positive or frictional fit indicated above. Furthermore, the production costs can be kept low since the working step of forming the thread is no longer required.

In embodiments, the longitudinal channel preferably has over its length a constant cross section. This simplifies the production of a connection element named at the outset rather significantly. The longitudinal channel can, for example, have the shape of a hollow cylinder, such that a tool that is guided through the longitudinal channel is not obstructed by any narrow spaces or the like. The tool can then have the largest possible cross section, such that it is capable of transferring forces to the end section to a sufficient extent.

In embodiments, the stem preferably has an outer diameter of at least 8 mm, and more preferably at least 10 mm. The connection element is thus able to replace an 8 mm or 10 mm screw. In many cases, even larger diameters are used, e.g., 12 mm, 15 mm or more. The larger the outer diameter of the connection element, the greater the stresses that a connection element of this type can usually absorb.

In embodiments, the wall preferably has a radial thickness of at least 1 mm, and more preferably at least 1.2 mm. In many cases, larger wall thicknesses can also be used, e.g., 1.5 mm or more. The thickness of the wall also has an influence on the shearing force and the loadability of the connection element. However, the deformation resistance of the stem also increases with a greater wall thickness. This is, however, completely acceptable within certain limits.

The outer diameter and the wall thickness depend on the shearing forces necessary for the connection.

In embodiments, the set head preferably turns into the stem via a conically formed surface. The connection element is embodied with a countersunk head such that, in the case of an adequate embodiment of the structural elements that are to be connected, it can be installed flush with the surface of the corresponding structural element.

According to embodiments, a setting device of the type generally described at the outset also includes a pulling head that is, at least on its free end, expandable in a radial direction.

Thus, the pulling head is placed into the connector and guided through the longitudinal channel until the free end, i.e., the end at a distance from the counter-holder, reaches the end section or even passes through it. If the pulling head is then expanded on its free end, it can exert forces to a sufficient degree on the end section of the stem in order to deform the stem during a subsequent pulling on the end section. The operating principle of a setting device of this type is thus relatively simple. Only a retracting and expanding of the pulling mandrel is required before the necessary setting force can be produced by pulling on the pulling head. After the completed deformation of the stem, the pulling head only needs to be made smaller again in a radial direction such that it can be moved out of the connection element again through the longitudinal channel.

Here, it is preferred that the pulling head has at least two tool elements and one spreader device. The spreader device ensures that the two tool elements can, at least on the free end of the pulling head, be distanced from one another such the radial expansion can be achieved.

This can be accomplished in a preferred embodiment in that the spreader device can be moved between the tool elements in a direction of pull. The spreader device then presses the tool elements apart from one another such that the pulling head expands. This spreading can either be achieved over the entire length of the tool elements, or the spreading can be limited to the region of the free end of the pulling head.

In an alternative embodiment, the tool elements can be pivoted relative to one another about a pivot axis and that the spreader device can have a tensioning device that is arranged on the side of the pivot axis facing away from the free end. The tensioning device then presses the two tool elements together. This pressing together is converted into a moving apart of the tool elements in the region of the free end of the pulling head by the pivot axis. An expansion of the pulling head on its free end can also be achieved hereby.

In a preferred embodiment, the tool elements have on their radial outside at least one sharp edge, in particular in the shape of a toothing. A toothing of this type can, for example, have a series of triangular points. If the pulling head expands in the region of the free end, then the sharp edges dig into the inside of the end section. A positive and frictional connection is hereby created, by which the tensile forces can be exerted on the end section to a sufficient extent. The tool elements then only need to be moved in a direction out of the connection element in order to deform the stem over the end section.

Here, it is preferred that the spreader device has a cone which is arranged in the region of the free end of the tool elements and the diameter of which increases in a direction away from the counter-holder. If the cone is pulled in between the tool elements, then it presses the tool elements apart from one another such that they can bear for example against the inside of the end section or dig into the inside of the end section using their sharp edge.

Here, it is preferred that the spreader device is embodied as a pulling rod. The pulling rod then has the cone in the region of the free end. This enables a very simple setting procedure. The pulling rod is first moved to a sufficient extent through the tool elements such that the cone protrudes from the tool elements in the region of the free end. In this state, the pulling rod can be moved with the tool elements through the longitudinal channel without this movement being obstructed by any elements. When the tool elements have then arrived in the region of the end section with the sharp edge or with other manners of force transfer, the direction of movement of the pulling rod is simply reversed and the pulling rod is moved in a direction out of the connection element. Here, the tool elements are first secured such that they cannot move in a direction of pull with the pulling rod, but are spread apart by the cone at the pulling rod. When the necessary engagement between the tool elements and the end section has been produced, the tool elements are moved together with the pulling rod in a direction out of the connection element such that the necessary tensile force can be exerted on the end section via the tool elements that results in the deformation of the stem.

Here, it is preferred that the cone has a step that can be brought to bear against the free end of the tool elements. This step limits the spreading procedure. When the cone has come to bear against the free end of the tool elements with the step, a further spreading is no longer possible. An inadvertent jamming of the tool elements in the end section or in another position is hereby prevented.

In an alternative embodiment, it can be provided that the tool elements respectively have a projection that forms a contact surface on its side facing the counter-holder. In this case, the tool elements must be guided through the longitudinal channel far enough so that the projection protrudes from the stem. If the tool elements are then spread and the tool elements are moved in the opposing direction, that is, in a direction out of the connection element, then the contact surfaces come to bear against the free front face of the end section and can hereby transfer the necessary tensile forces to the end section.

In embodiments, the pull drive preferably is fed by a battery. Expediently, the battery will be a rechargeable battery. The setting device hereby becomes very flexible in its handling, as no supply lines need to be carried along.

Embodiments of the invention are directed to a connection element that includes a set head and a stem, including a wall surrounding a longitudinal channel, connecting to the set head. The wall has at least one longitudinal slot located between the set head and an end section facing away from the set head, and the end section is smooth on an inside facing the longitudinal channel.

According to embodiments of the instant invention, the longitudinal channel can have a constant cross section over its length.

In accordance with other embodiments, the stem may have an outer diameter of at least 8 mm. Further, the stem can have an outer diameter of at least 10 mm.

According to other embodiments, the wall can have a radial thickness of at least 1 mm. Moreover, the wall may have a radial thickness of at least 1.2 mm.

According to still other embodiments of the invention, the set head can include a conical surface connecting to the stem.

Embodiments of the invention are directed to a setting device for a connection element having a set head and a stem connecting to the set head and having a wall surrounding a longitudinal channel, the wall having at least one longitudinal slot between the set head and an end section facing away from the set head. The setting device includes a counter-holder, a pull drive, and a pulling head movable by the pull drive in a pulling direction relative to the counter-holder. The pulling head is, at least on a free end, expandable in a radial direction.

According to embodiments, the pulling head may include at least two tool elements and one spreader device. Further, the spreader device between the tool elements may be movable in the pulling direction. Also, the tool elements may be pivotable relative to one another about a pivot axis and the spreader device can have a tensioning device arranged on a side of the pivot axis facing away from the free end. The tool elements can have radial outsides with at least one sharp edge, and the at least one sharp edge may form a toothing. The spreader device can include a cone that is positionable in a region of free ends of the tool elements and that has an increasing diameter in a direction away from the counter-holder. The spreader device can also include comprises a pulling rod. Further, the cone can have a step positionable to bear against the free ends of the tool elements. The tool elements can have respective projections forming contact surfaces arranged to face the counter-holder.

In accordance with still other embodiments of the invention, the pull drive may be fed by at least one of a battery supply, a hydraulic supply, a pneumatic supply or a hydropneumatic supply.

Embodiments of the invention are directed to a connection element setting system. The connection element setting system includes a pulling head structured and arranged for movement in a pulling direction toward a counter holder. The pulling head includes at least two projections movable relative to each other in a direction transverse to the pulling direction; and the at least two projections each include contact surfaces facing the counter holder that are structured and arranged to contact free ends of a connection element.

In accordance with still yet other embodiments of the present invention, the connection element setting system can further include a connection element having a stem formed by a wall defining a longitudinal channel and an end section, a set head connected to the stem at an end opposite the end section, and at least one slot formed in the wall between the stem and end section. The at least two projection heads can be positionable to contact each other to pass entirely through the longitudinal channel, and to move away from each other exert a compression force on the stem.

Other exemplary embodiments and advantages of the present invention may be ascertained by reviewing the present disclosure and the accompanying drawing.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 shows a connection element in longitudinal section and in cross section;

FIG. 2 shows a schematic representation of a setting device;

FIGS. 3a-3c show a first embodiment of a pulling head in a schematic representation;

FIGS. 4a-4c show a second embodiment of a pulling head in a schematic representation; and

FIGS. 5a-5c show a third embodiment of a pulling head in a schematic representation.

### DETAILED DESCRIPTION OF THE EMBODIMENTS

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

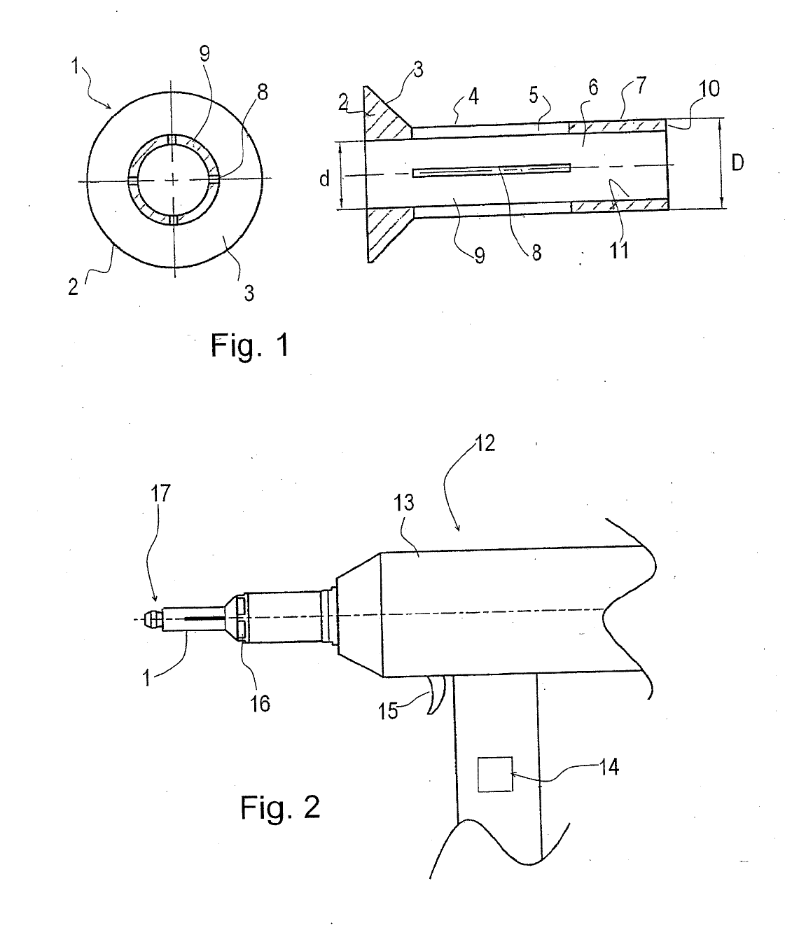

FIG. 1 shows a cross section through a connection element 1, as well as a longitudinal section through the connection element 1.

Connection element 1 has a set head 2 which turns into a stem 4 via a conically embodied surface 3. Stem 4 connects to set head 2. Stem 4 has a wall 5 that surrounds a longitudinal channel 6. Stem 4 has an end section 7 facing away from set head 2. Between set head 2 and end section 7, multiple longitudinal slots 8 are arranged distributed in a circumferential direction. Stem regions 9 remain between longitudinal slots 8. Stem 4 has on its end facing away from set head 2 a front face 10. End section 7 has an inside 11 facing longitudinal channel 6 that is smooth. By the term “smooth,” it is understood that inside 11 does not have any attachment contours for the attachment of a tool to transfer tensile forces resulting in deformation of stem regions 9.

Longitudinal channel 6 has a constant cross section over the length of the connection element 1. Preferably, longitudinal channel 6 is embodied as a hollow cylinder.

Stem 4 of connection element 1 has an outer diameter D of at least 8 mm. Preferably, outer diameter D is even larger and is, e.g., 10 mm, 12 mm or 15 mm.

Longitudinal channel 6 has a diameter d which is smaller than outer diameter D by two times a radial thickness of wall 5. The radial thickness of wall 5 is at least 1 mm, and preferably at least 1.2 mm, and even more preferably at least 1.5 mm.

A connection element of this type having an outer diameter D of 12 mm for stem 4, can replace an M12 screw without difficulty.

FIG. 2 shows a setting device 12 suitable for setting connector 1 as described above with a pull drive 13 which is supplied with electric power from a battery 14 when an actuator lever 15 is operated. In place of an electric power supply, a hydraulic, pneumatic or hydropneumatic power supply can also be used.

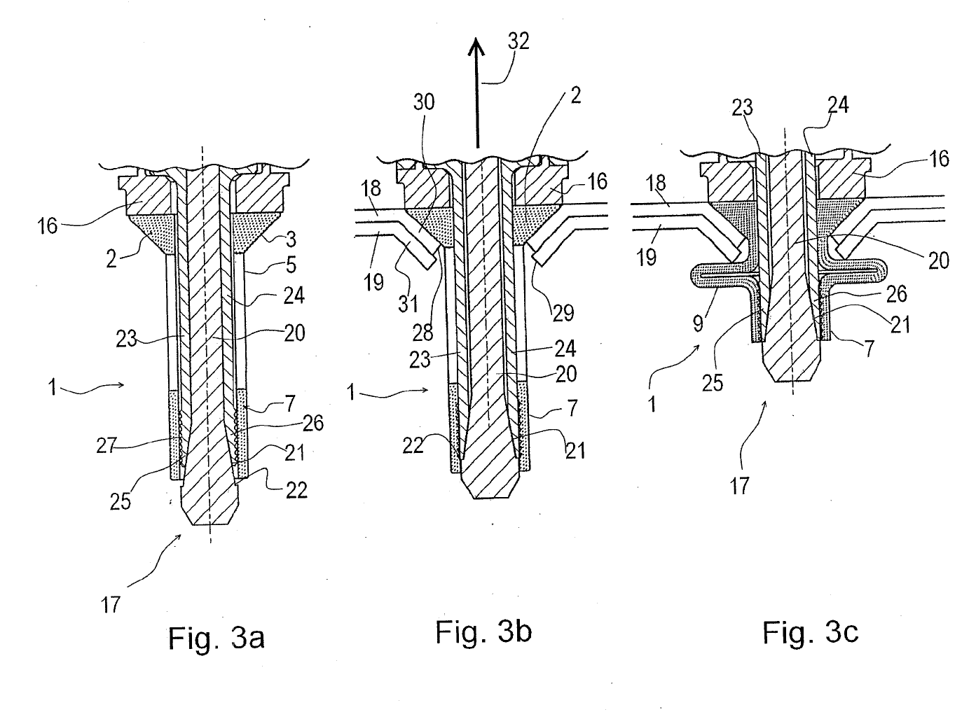

In the illustration, connection element 1 is already placed on setting device 2 so that connection element 1 bears against a counter-holder 16. A set head 17, several embodiments of which are explained in further detail below with reference to FIGS. 3 through 5, is guided through connection element 1 to protrude from connection element 1. Pulling head 17 can be moved in a direction towards counter-holder 16 by pull drive 13, thereby exerting a force on end section 7 sufficient to deform stem regions 9.

FIGS. 3a-3c show a first embodiment of pulling head 17. As shown, FIG. 3a shows connector 1 on pulling head 17; FIG. 3b shows connector 1, at a start of the setting procedure, having been guided through bores in two plates 18, 19 arranged to lie on top of one another; and FIG. 3c shows connector 1 at the end of the setting procedure.

Pulling head 17 has a pulling rod (or mandrel) 20 provided with a cone 21 towards its free end. Cone 21 has a diameter that increases in a direction toward the free end or away from counter-holder 16. A step 22 is connected to cone 21. A largest diameter of pulling rod 20 in the region of its free end 25 is somewhat smaller than inner diameter d of longitudinal channel 6, so that pulling rod 20 can be guided through longitudinal channel 6 over its entire length without problems.

Pulling rod 20 is arranged between two tool elements 23, 24. Tool elements 23, 24 have internally a conical widening on their free ends 25, 26, which are shown located in positions inside end section 7, see FIG. 3a. This widening is adjusted to cone 21.

On their radial outside, ends 25, 26 are provided with multiple sharp edges 27, which can for example be formed by a toothing of projections embodied in a triangular shape.

In the position illustrated in FIG. 3a, pulling rod 20 has been guided far enough through connection element 1 so that there is still sufficient space available between pulling rod 20 and wall 5 in longitudinal channel 6 to accommodate the two tool elements 23, 24. In place of the two tool elements 23, 24 described, additional tool elements can of course also be provided, for example, three or four tool elements, distributed equally around pulling mandrel 20 in a circumferential direction.

As illustrated in FIG. 3b, connector 1, which can be slid onto pulling head 17, can then be guided through two structural elements, e.g., plates 18, 19 or profiles. The two plates 18, 19 have respectively corresponding pass-through openings 28, 29. The two plates 18, 19 can be provided with conical deformations 30, 31 in the region of pass-through openings 28, 29 that match surface 3 of set head 2, in order to also achieve a positive fit between the two plates 18, 19.

Once connector 1 has been guided through pass-through openings 28, 29 until set head 2 bears against deformation 30 of plate 18, pulling rod 20 is moved in a direction 32 into connection element 1. Tool elements 23, 24 are initially secured against longitudinal movement in direction 32 until step 2 of pulling rod 20 comes to bear against tool elements 23, 24. However, the initial movement of pulling rod 20 produces, via cone 21, a spreading apart of tool elements 23, 24 away from one another so that edges 27 of tools 23, 24 dig into the inside wall of longitudinal section 7 to produce a non-positive connection, which is illustrated in FIG. 3b.

As pulling rod 20 is further pulled in direction 32, edge 22 of pulling rod 20 carries along tool elements 23, 24, which transfer the tensile force of pulling rod 20 to end section 7. The tensile force acting on end section 7 causes stem regions 9 to be deformed radially outwards and to then bear against plate 19, as illustrated in FIG. 3c.

Once this deformed state is reached, pulling rod 20 only needs to be moved again slightly against direction 32, i.e., until cone 21 comes clear of ends 25, 26 of tool elements 23, 24. As a result of this reverse movement of pulling rod 20, tool elements 23, 24 can be moved radially inwards again, e.g., either because of their own spring effect or because of an annular spring (not illustrated). Once ends 25, 26 of tool elements 23, 24 have come clear of end section 7, the entire pulling head 17 can be pulled out of set connection element 1.

With this pull out of pulling head 17, the setting procedure is concluded.

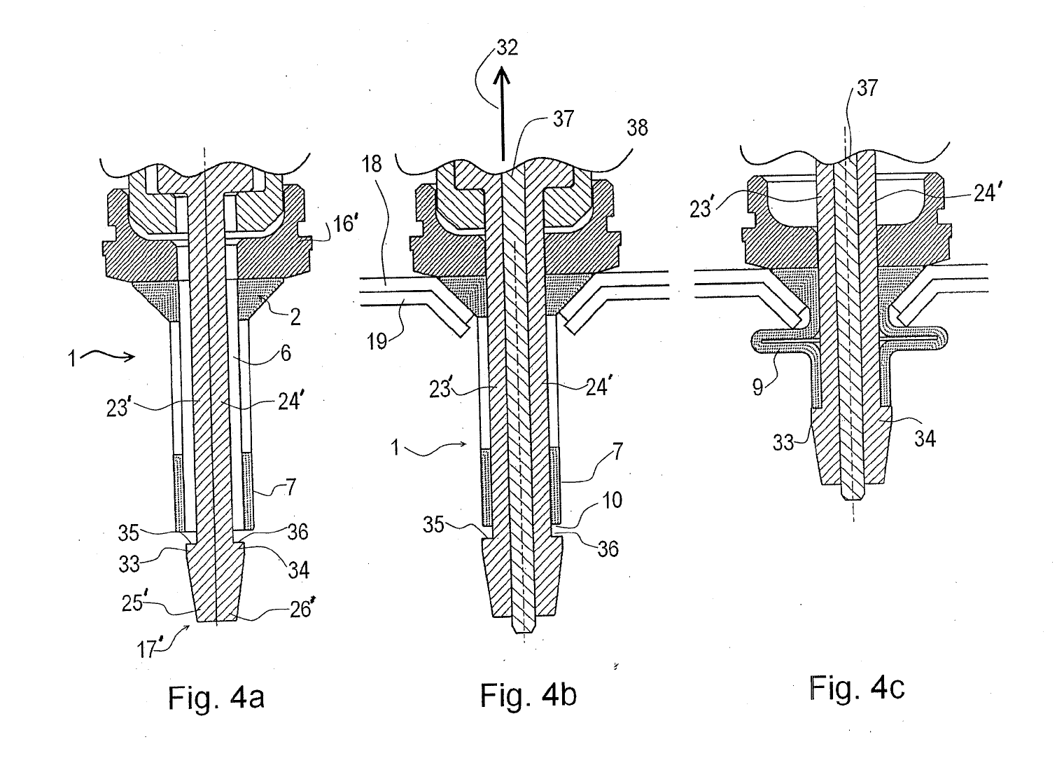

FIGS. 4a-4c show a modified embodiment of a pulling head 17′. Elements identical to those in FIGS. 1 through 3c are provided with the same reference numerals.

In the embodiment according to FIG. 4a, tool elements 23′, 24′ have in respective regions of their free ends 25′, 26′ projections 33, 34 that form contact surfaces 35, 36 facing counter-holder 16. Together, projections 33, 34 have a cross section that still fits through longitudinal channel 6 so that tool elements 23′, 24′ can be guided through the entirety of connection element 1 until free ends 25′, 26′ protrude from connection element 1′, as illustrated in FIG. 4a. When connection element 1′ has been placed on pulling head 17′ and has been guided through plates 18, 19, a spreading element 37 is slid between the two tool elements 23′, 24′ so that the two tool elements 23′, 24′ obtain over their entire length a distance (lateral to a longitudinal direction of spreading element 37) to one another defined by spreading element 37, see FIG. 4b. This distance is large enough so that contact surfaces 35, 36 come to overlap front face 10 of connection element 1. When the two tool elements 23′, 24′ are moved in pulling direction 32, e.g., by a corresponding pulling mechanism 38, contact surfaces 35, 36 come to bear against front face 10 and can thereby transfer the corresponding tensile forces to end section 7 of connection element 1. These tensile forces then lead, as in the above-described embodiment according to FIG. 3, to a deformation of stem regions 9, see FIG. 4c.

Once spreading element 37 between the two tool elements 23′, 24′ is removed, projections 33, 34 come clear of the end section 10 and can be pulled out of the connection element 1.

In the embodiments according to FIGS. 4a-4c, it is expedient to introduce spreading element 37 between the two tool elements 23′, 24′ from the side of counter-holder 16′.

Of course, a spreading element 37 of this type can also be used if the tensile force is not to be transferred from tool elements 23′, 24′ to end section 7 via contact surfaces 35, 36 but rather by sharp edges 27, as they are illustrated in FIG. 3, or by a frictional fit.

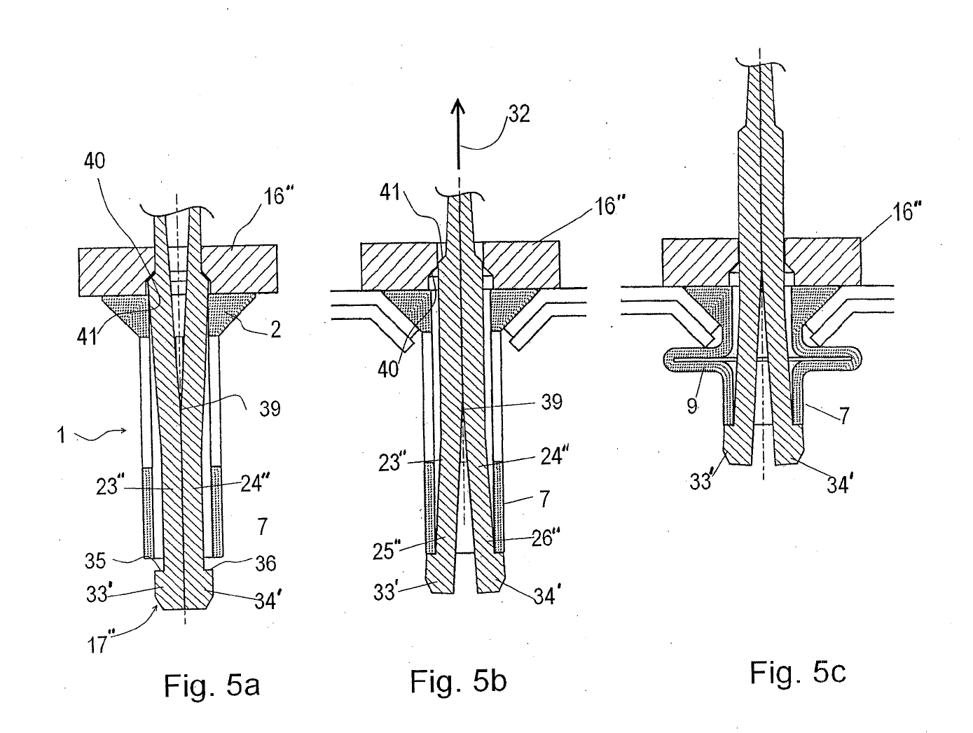

FIGS. 5a-5c show a further embodiment of a pulling head 17″, in which elements identical to those in FIGS. 1 through 4 are provided with the same reference numerals. The embodiment according to FIGS. 5a-5c use projections 33′, 34′ having contact surfaces 35, 36 on tool elements 23″, 24″. However, projections 33′, 34′ can also be provided with an engagement geometry, formed, e.g., by sharp edges 27 as illustrated in FIGS. 3a-3c.

In the embodiment according to FIGS. 5a-5c, the two tool elements 23″, 24″ do not run parallel over the entirety of their lengths on their sides facing one another. Instead, there is a pivot axis 39 up to which (from the free end) the sides run parallel to each other, as illustrated in FIG. 5a and after which they diverge in a direction towards counter-holder 16″.

Counter-holder 16″ has sloped surfaces 40 which interact with corresponding sloped surfaces 41 on tool elements 23″, 24″ in the region of counter-holder 16″. If the two tool elements 23″, 24″ are moved in pulling direction 32, these sloped surfaces 40, 41 cause the two tool elements 23″, 24″ to bear against one another on their ends that are guided through counter-holder 16″ and to distance themselves from one another on their other (free) ends 25″, 26″ so that projections 33′, 34′ overlap end section 7, as illustrated in FIG. 5b. Through a further movement of tool elements 23″, 24″ in pulling direction 32, a deformation of stem regions 9 then occurs, as this is illustrated in FIG. 5c. The releasing of tool elements 23″, 24″ from connection element 1 occurs through a movement against pulling direction 32 until the state of FIG. 5a, i.e., the projections 33′, 34′ are positioned against each other, is again reached. Pulling head 17″ is subsequently removed from connection element 1 altogether.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

What is claimed:

1. A connection element comprising:
a set head;
a stem, comprising a wall surrounding a longitudinal channel, connecting to the set head;
the wall having at least one longitudinal slot located between the set head and an end section facing away from the set head; and
the end section being smooth on an inside facing the longitudinal channel.

2. The connection element according to claim 1, wherein the longitudinal channel has a constant cross section over its length.

3. The connection element according to claim 1, wherein the stem has an outer diameter of at least 8 mm.

4. The connection element according to claim 3, wherein the stem has an outer diameter of at least 10 mm.

5. The connection element according to claim 1, wherein the wall has a radial thickness of at least 1 mm.

6. The connection element according to claim 5, wherein the wall has a radial thickness of at least 1.2 mm.

7. The connection element according to claim 1, wherein the set head comprises a conical surface connecting to the stem.

8. A setting device for a connection element having a set head and a stem connecting to the set head and having a wall surrounding a longitudinal channel, the wall having at least one longitudinal slot between the set head and an end section facing away from the set head, the setting device comprising:
a counter-holder;
a pull drive;
a pulling head movable by the pull drive in a pulling direction relative to the counter-holder; and
the pulling head being, at least on a free end, expandable in a radial direction.

9. The setting device according to claim 8, wherein the pulling head comprises at least two tool elements and one spreader device.

10. The setting device according to claim 9, wherein the spreader device between the tool elements is movable in the pulling direction.

11. The setting device according to claim 9, wherein the tool elements are pivotable relative to one another about a pivot axis and the spreader device has a tensioning device arranged on a side of the pivot axis facing away from the free end.

12. The setting device according to claim 9, wherein the tool elements have radial outsides with at least one sharp edge.

13. The setting device according to claim 12, wherein the at least one sharp edge forms a toothing.

14. The setting device according to claim 9, wherein the spreader device comprises a cone that is positionable in a region of free ends of the tool elements and that has an increasing diameter in a direction away from the counter-holder.

15. The setting device according to claim 9, wherein the spreader device is comprises a pulling rod.

16. The setting device according to claim 14, wherein the cone has a step positionable to bear against the free ends of the tool elements.

17. The setting device according to claim 9, wherein the tool elements have respective projections forming contact surfaces arranged to face the counter-holder.

18. The setting device according to claim 8, wherein the pull drive is fed by at least one of a battery supply, a hydraulic supply, a pneumatic supply or a hydropneumatic supply.

19. A connection element setting system comprising:
a pulling head structured and arranged for movement in a pulling direction toward a counter holder;
the pulling head comprising at least two projections movable relative to each other in a direction transverse to the pulling direction; and
the at least two projections each comprising contact surfaces facing the counter holder that are structured and arranged to contact free ends of a connection element.

20. The connection element setting system according to claim 19, further comprising a connection element having a stem formed by a wall defining a longitudinal channel and an end section, a set head connected to the stem at an end opposite the end section, and at least one slot formed in the wall between the stem and end section,
wherein the at least two projection heads are positionable to contact each other to pass entirely through the longitudinal channel, and to move away from each other exert a compression force on the stem.
